(19) United States
(12) Patent Application Publication
(10) Pub. No.: US 2009/0115204 A1
(43) Pub. Date: May 7, 2009

(54) Self latching latch

(76) Inventor: Alexander Neal Rycroft, Auchenflower (AU)

Correspondence Address: Hoffman, Wasson & Gitler, P.C., Suite 522, 2461 South Clark Street, Arlington, VA, 22202, US

(21) Appl. No.: 12/289,177

(22) Filed: Oct. 22, 2008

(30) Foreign Application Priority Data
Oct. 24, 2007 (AU) 2007905808

(51) Int. Cl. E05B 15/02; G04B 15/14; E05B 47/06

(52) U.S. Cl. 292/341.17; 74/1.5; 70/276

(57) ABSTRACT

A self latching latch mechanism is disclosed which includes a latch mounted to a first wing and a strike mounted to a second wing or a fixed member. The latch has a latch tongue which can move between a latching position in which the latch tongue can engage the strike to secure the first wing relative to the second wing or fixed member, and a free position which allows relative movement between the first wing and the second wing or fixed member. Latch tongue biasing means are provided to bias the latch tongue towards the latching position. Operating means are also provided to move the latch tongue from the latching position to the free position, and there is a hold back member which can move between a first position in which the latch tongue is prevented from moving to the latching position, and a second position in which the latch tongue can move to the latching position. The hold back member is biased to the first position. There is also a latch magnet associated with the hold back member, and means to prevent the latch tongue from moving from the latching position to the free position otherwise than upon operation of the latch tongue operating means. The strike also has a strike magnet. When the latch is close enough to the strike for the latch tongue to engage the strike the hold back member is caused to move from the first position to the second position by attractive or repulsive magnetic forces between the latch magnet and the strike magnet, thereby allowing the latch tongue to move from the free position to the latching position.

### FIELD OF THE INVENTION

The present invention applies to locks and latches for use with openable and closable wings. The invention may find particular application in relation to double hung windows. However, the invention may also be used in a wide range of other applications or with alternative forms of openable and closable wings.

### BACKGROUND

In general, locks and latches have a latch tongue. The lock/latch is typically mounted to an openable and closable wing (e.g. to a window or door), and the tongue is adapted to extend out from the body of the lock/latch so that the tongue engages with a strike mounted to either an adjacent wing (e.g. an adjacent sliding window) or to a fixed member (e.g. a door jam). The position of the tongue where it engages with the strike may be described as the “latching position”. Hence, the engagement of the tongue with the strike prevents the lock/latch from being separated from the strike, thereby preventing the openable and closable wing from separating from the adjacent wing or fixed member. Lock/latch tongues are typically biased towards the latching position so that the tongue automatically adopts the latching position when the lock/latch is brought into engagement with the strike.

There are two main types of latch tongue used in most locks and latches, namely sliding latch tongues and rotating latch tongues. Sliding latch tongues slide in and out of the lock/latch, and they are typically used on pivoting wings such as hinged doors and windows. In contrast, rotating latch tongues typically incorporate a hooked portion or “parrot beak”, and the tongue typically pivots so that the hooked portion extends out of the lock/latch body to engage or “hook into” a keeper in the strike. Rotating latch tongues are more commonly used on sliding wings, or wings which slide relative to each other, such as sliding doors, sliding windows, double hung windows and the like.

As noted above, the latch tongues in most locks and latches are biased towards the latching position so that when the lock/latch is brought into engagement with the strike, the tongue can move under the bias into the latching position. However, as a consequence of this, many locks/latches often also incorporate a mechanism for holding the tongue back against the bias, in a position where the tongue cannot engage with the strike. This position may be referred to as the “free position” of the latch tongue. This hold back mechanism prevents the tongue from moving into the latching position except when the lock/latch is engaged with the strike, thereby preventing the tongue from prematurely projecting from the lock/latch and colliding with the strike (which could cause damage to the lock/latch or strike) as the lock/latch is brought into engagement with the strike.

Hold back mechanisms generally operate to retain the tongue in the free position after the tongue is moved into the free position (e.g. after the lock/latch is “unlatched” using the lock/latch handle to open the door or window). The hold back mechanism then retains the tongue in the free position until the wing is closed whereupon the strike is brought back into engagement with the lock/latch. When the strike engages with the lock/latch, the hold back mechanism is triggered or otherwise disengaged to allow the tongue to move into the latching position under the influence of the bias. This functionality where the hold back mechanism retains the tongue in the free position until the wing is closed but then allows the tongue to move into the latching position when the strike engages the lock/latch may be described as the “self latching” function of the lock/latch.

FIGS. 1 and 2 show a sliding door lock 1 with a rotating “parrot beak” type latch tongue 2, and which incorporates a hold back mechanism that gives the lock a self latching function. The lock 1 shown in FIGS. 1 and 2 is more fully described in co-pending international application PCT/AU2006/001744. The hold back mechanism comprises a hold back member 3 which is biased to pivot in the clockwise direction (in this view) by hold back spring 4. Hold back member 3 also has a notch 5. Notch 5 is adapted to capture the peg 6 (which is integrally formed on the top of latch tongue 2) when the latch tongue is pivoted into the free position. In FIG. 2, the latch tongue 2 is illustrated in the latching position and hence peg 6 is free of notch 5. When latch tongue 2 is pivoted into the free position (this is done by pivoting a handle and spindle which inserts into the square aperture in tongue 2), peg 6 becomes aligned with notch 5 and hold back member 3 then pivots under the bias of spring 4 to capture the peg in the notch, as shown in FIG. 1. Once peg 6 is captured by notch 5, the bias on latch tongue 2 created by spring member 7 (which biases the latch tongue in the clockwise direction) causes peg 6 to push against the side of notch 5, maintaining peg 6 in notch 5 and thereby preventing the latch tongue from rotating back into the latching position (until the hold back member is disengaged as described below).

FIG. 2 illustrates that hold back member 3 disengages to allow latch tongue 2 to pivot back into the latching position when strike 8 inserts substantially all the way into the lock (i.e. when the door is closed). Upon substantially full insertion of strike 8 into the lock, the strike nose 9 pushes on hold back member 3, causing the hold back member to pivot counter-clockwise (as shown in this view) against the bias of hold back spring 4. When hold back member 3 pivots counter-clockwise, notch 5 also rotates thus releasing peg 6 and thereby allowing latch tongue 2 to pivot clockwise into the latching position under the bias of spring 7. The contact between nose 9 and hold back member 3 then maintains hold back member 3 away from peg 6 until the latch tongue is again pivoted into the free position and the door is withdrawn from the strike (so that strike nose 9 withdraws out of the lock), whereupon the capture of peg 6 in notch 5 described above is repeated.

FIG. 3 shows an alternative door lock 1a of the type used on pivoting wings like swinging doors. Lock 1a has an “in-out” sliding latch tongue 2a and a hold back mechanism that operates with this sliding latch tongue to give the lock a self latching function. Lock 1a is more fully described in co-pending Australian application number 2004212561. The hold back mechanism comprises an auxiliary tongue 3a which is adapted to slide diagonally in and out of the lock body as shown in FIG. 3. The auxiliary tongue 3a is biased by spring 4a towards a position where it extends diagonally downwardly out from the lock body.

In FIG. 3, lock 1a is shown with latch tongue 2a in the latching position. Therefore, in this position, lock 1a would be engaged with a strike (although the strike is not shown). The latch tongue 2a is extended to insert into an opening in the strike to thereby maintain the lock 1a in engagement with the strike. However, the auxiliary tongue 3a does not insert into an opening in the strike. Instead, it is pushed diagonally back upwards into the body of lock 1a (against the bias of spring 4a) when the lock comes into contact with the strike.

Auxiliary tongue 3a has a downwardly extending leg portion 5a. Leg portion 5a is adapted to engage with an upwardly protruding portion 6a on the top rear of latch tongue 2a. In the configuration shown in FIG. 3 (i.e. where the lock is engaged with the strike and the latch tongue 2a is in the latching position), the auxiliary tongue 3a is retracted diagonally back up into the lock body and therefore leg portion 5a does not engage with protruding portion 6a. However, when the lock is operated to retract the latch tongue 2a (this is done by operating a handle which is not shown), the wing (i.e. the door etc) is able to swing away from the strike. As the wing draws away from the strike, the auxiliary tongue 3a extends out from within the lock body. It will also be recalled that the latch tongue 2a is retracted back into the lock body to allow the lock 1a to disengage from the strike. Consequently, as auxiliary tongue 3a extends out from within the lock body, the leg portion 5a moves down in the direction shown by arrow “A” in FIG. 3 such that at least a part of the leg portion 5a inserts into the space between the projecting portion 6a and the fixed post on the lock body. The presence of leg portion 5a between projecting portion 6a and the post then impedes the latch tongue 2a from extending all the way back out of the lock body. The latch tongue 2a is only able to slide back out from within the lock body when the lock 1a is again brought into engagement with the strike, whereupon auxiliary tongue 3a will again be pushed back upwards into the lock body, thereby moving leg portion 5a back out from in between projecting portion 6a and the post, and therefore allowing the latch tongue to extend all way out.

The trouble with hold back mechanisms like the ones described with reference to FIGS. 1-3 (and with similar mechanisms) is that it is still possible to trigger or release the hold back mechanism even before the lock is brought into engagement with the strike. For example, in the lock in FIGS. 1-2, the hold back mechanism could be triggered to allow the latch tongue 2 to “latch” simply by inserting a finger or some other elongate implement into the lock to push on hold back member 3 and thereby release the latch tongue 2. Similarly, in the lock in FIG. 3, the hold back mechanism could be triggered even when the lock is not disengaged with the strike simply by pushing the auxiliary tongue 3a into the lock body.

Similar problems also arise in relation to the locks and latches used on sliding windows and double hung windows. Sliding and double hung windows are typically latched by cam latches. Cam latches typically have a rotating hook-type latch tongue on one sash that engages with a strike fixed to the adjacent sash. When engaged in the strike, the hook tongue prevents the sashes from opening in the normal fashion, and it prevents movement of one sash relative to the other in the direction perpendicular to the plane of the sashes. In this way, the cam latches provide some security against forced entry due to an object being forced between the overlapping sashes to prize them apart.

A problem experienced with the cam latches described above is that they can be activated even when the window is open. If the latch is operated to move the latch tongue into the latched position and the sash is then closed with the tongue in the latched position, the projecting tongue will strike the frame or some other part of the adjacent sash, possibly causing damage to both the tongue and/or the adjacent sash.

Attempts have been made to create latches for sliding windows and double hung windows that overcome this problem. However, the arrangements arrived at in these previous attempts typically do not restrain the sashes in the direction perpendicular to the plane of the sashes. Therefore, an additional mechanism is required if security is to be provided against forcing an object between the overlapping sashes to prise them apart.

It is an object of the present invention to provide a latch (which may also be incorporated as part of a lockable lock) which helps to address or at least ameliorate one or more of the above-mentioned problems, or which at least provides a useful or commercial alternative to existing products in the marketplace. However, it will be clearly understood that any reference herein to prior or existing locks, latches or any other prior or background information (including documents) does not constitute an acknowledgement or admission that any prior or existing latches, locks or any other information of whatever kind, whether considered separately or in combination, ever formed part of the common general knowledge in the field, or is otherwise admissible prior art, whether in Australia or in any other country.

### SUMMARY OF THE INVENTION

In one form, the present invention resides broadly in a latch for use with an openable and closable wing comprising
a latch tongue which can move between a latching position and a free position,
biasing means to bias the latch tongue towards the latching position, and
hold back means to prevent the latch tongue from moving to the latching position except when the latch is close enough to an associated strike for the latch tongue to engage the strike
   wherein the hold back means is magnetically operated when the latch is close enough to the strike for the latch tongue to engage the strike such that the latch tongue can move to the latching position and engage the strike.

By making the hold back means magnetically operated, the present invention can provide a self latching function without the need for physical actuation of the hold back means to release the latch tongue. This is in contrast to arrangements like those described in the background section above in which the auxiliary tongue or other hold back mechanism requires physical actuation (typically by contacting the strike) to release the latch tongue for movement into the latching position. Because physical contact is not required with the present invention to operate the hold back means, the present invention may help to reduce the possibility of the latch tongue prematurely “latching”, as is possible with the arrangements described in the background section above.

In another form, the present invention resides broadly in a hold back mechanism for, or used in, a lock or latch of the type which has a latch tongue which can move between a latching position and a free position and biasing means to bias the latch tongue towards the latching position, wherein the hold back mechanism
prevents the latch tongue from moving to the latching position when the lock or latch is separated from an associated strike, and
can be magnetically operated, when the latch is close enough to the strike for the latch tongue to engage the strike, so that it does not prevent the latch tongue from moving to the latching position.

The hold back mechanism in this form of the invention will preferably include a hold back member. When the lock or latch is separated from the strike, the hold back member may adopt a first position which causes the latch tongue to be prevented from moving to the latching position. Conversely, as the lock or latch engages the strike, or moves close enough to the strike for the latch tongue to engage the strike, the hold back member may adopt a second position which does not cause the latch tongue to be prevented from moving into the latching position.

In a further form, the present invention resides in a latch mechanism including
a latch mounted to a first wing and
a strike mounted to a second wing or a fixed member,
   the latch having
a latch tongue which can move between a latching position in which the latch tongue can engage the strike to secure the first wing relative to the second wing or fixed member, and a free position which allows relative movement between the first wing and the second wing or fixed member,
latch tongue biasing means to bias the latch tongue towards the latching position, and
a hold back member which can move between a first position in which the latch tongue is prevented from moving to the latching position, and a second position in which the latch tongue can move to the latching position,
hold back member biasing means to bias the hold back member to the first position, and
a latch magnet associated with the hold back member
   the strike having a strike magnet

whereby when the latch is close enough to the strike for the latch tongue to engage the strike the hold back member is caused to move from the first position to the second position by attractive or repulsive forces between the latch magnet and the strike magnet, thereby allowing the latch tongue to move from the free position to the latching position.

The present invention may also be implemented as a lockable lock incorporating a latch, latch mechanism, or a hold back mechanism in accordance with any one of the forms of the invention described above.

As noted at the outset, the present invention applies to locks and latches for use with openable and closable wings. It is envisaged that one particular application of the invention will be in relation to double hung windows. However, the invention could also be applied to locks and latches used on a wide range of other openable and closable wings. To provide just some examples, the invention could be applied to locks and latches used with pivoting wings including hinged windows and doors, sliding wings including sliding doors and windows, and also roller doors, gates, closable lids for chests, boxes, cabinets and the like, etc. Those skilled in this area may recognize other possible types of openable and closable wings with which the invention may suitably be used, all of which are deemed to fall within the scope of the intended applications for the invention.

In all forms of the invention, the lock or latch used will have a latch tongue. The type of latch tongue is not narrowly critical. For instance, the latch tongue may be a sliding latch tongue of the kind that inserts into a strike situated in a door/window frame or other fixed member. Latch tongues such as this are commonly used on swinging wings (like hingedly opening and closing doors and windows), and if the latch tongue is a sliding latch tongue the strike will typically have a recess therein so that insertion of the latch tongue into the recess when the door/window is closed prevents the door/window from swinging open.

Alternatively, the latch tongue may be a rotating latch tongue. A wide variety of shapes, sizes and configurations of rotating latch tongue may be used with the present invention, and rotating latch tongues may be particularly useful where the lock is applied to sliding wings like sliding windows, sliding doors, double hung windows etc. Where the invention is used in a lock or latch for double hung windows or the like, rotating latch tongues may also provide advantages in terms of providing security against separation between the lock/latch and the strike in the direction perpendicular to the plane of the window(s) (for example by inserting something between the lock/latch and the strike to try and prize them apart).

If the latch tongue is a rotating latch tongue, the latch tongue, or a portion thereof, may have a substantially hooked shape adapted to hook into, or hookingly engage with, the strike or a part of the strike. The part of the strike which the hooked portion of the latch tongue engages may be a protruding portion of the strike, or a recess in the strike which the hooked portion of the latch tongue can insert in, around or otherwise hook into. This engagement between the latch tongue and the strike may prevent relative movement between the door, window or other wing to which the lock or latch is mounted and the door, window, wing or fixed member to which the strike is mounted.

The position of the latch tongue wherein the latch tongue prevents relative movement (in at least one direction) between the door, window or other wing to which the lock or latch is mounted and the door, window, wing or fixed member to which the strike is mounted may be referred to as the latching position of the latch tongue. In the case of a sliding latch tongue, the latching position is generally where the latch tongue is inserted into the strike to prevent the door/window from swinging open. For rotating latch tongues, the latching position is generally where the hooked portion hookingly engages the strike to prevent the door/windows/wing to which the lock or latch is mounted from moving (in at least one direction) relative to the door/windows/wing/fixed member to which the strike is mounted.

The latch tongue in the present lock or latch may be moved by operating a handle of the lock or latch. For sliding latch tongues, the handle may engage with the latch tongue via a latch tongue retracting mechanism so that operation of the handle (typically by turning or sliding the handle) causes the latch tongue to retract from or out of the strike, thereby allowing the wing (e.g. a swinging door) to open. Latch tongue retracting mechanisms such as this are in common usage with sliding latch tongues.

In the case of a rotating latch tongue, the handle may be operatively associated with the latch tongue so that the movement of the handle causes the latch tongue to rotate out of engagement with the strike. In preferred embodiments, a spindle member may be provided that is functionally associated with the handle and the latch tongue so that pivoting the handle causes the latch tongue to rotate, at least in one direction. The spindle may be a solid spindle, or a split or partial spindle, and it will preferably have a square, rectangular or other non-circular cross-section.

In either case, (i.e. for sliding latch tongues or rotating latch tongues), when the latch tongue is moved into a position which allows relative movement between the wing to which the lock or latch is mounted and the wing or fixed member to which the strike is mounted, the latch tongue may be said to be in the free position.

The handle of the present lock or latch may be of any size, shape or configuration suitable to enable the handle to be manually operated (typically, but not necessarily, by hand). Examples of the kinds of handle that may be used include conventional door knobs or levers, or the pivoting lever-like members commonly used on sliding doors and windows. The handle will typically be made from relatively stiff and strong materials such as metals or resilient plastics, as may the rest of the external furniture of the lock/latch.

The latch tongue of the present invention may be biased towards the latching position. The nature of the latch tongue biasing means is not narrowly critical. In other words, any means for biasing the latch tongue towards the latching position may be used. Some possible biasing means include helical, cantilever, leaf, bar or other types of springs, resilient or compliant components or mechanisms such as elastomeric components, elastic bands, camming arrangements made resilient by any of the above-mentioned means, etc. These are just examples, and those skilled in this area may recognize other possible ways of biasing the latch tongue towards the latching position, all of which are deemed to be covered.

The invention also incorporates hold back means for preventing the latch tongue from moving to the latching position except when the latch is close enough to the strike for the latch tongue to engage the strike. Suitably, the hold back means may hold the latch tongue in the free position against the bias imposed by the above mentioned latch tongue biasing means, again, except when the latch is close enough to the strike for the latch tongue to engage the strike.

The hold back means will generally be engaged to retain the latch tongue in the free position when the latch tongue is moved into the free position by operating the handle (i.e. when the handle is operated to open the door, window or other wing). The hold back means may then retain the latch tongue in the free position until movement of the wing in the closing direction causes the lock or latch to move close enough to the strike for the latch tongue to engage the strike.

When the lock or latch moves close enough to the strike for the latch tongue to engage the strike, the hold back means may be triggered or otherwise disengaged to allow the latch tongue to move into the latching position under the influence of the biasing means. Configuring the lock or latch so that the latch tongue is only released to move into the latching position when the lock or latch moves close enough to the strike for the latch tongue to engage the strike, may help to prevent premature movement of the latch tongue into the latching position. This may in turn eliminate or at least substantially reduce the risk of the latch tongue moving into the latching position while the wing to which the lock or latch is mounted is separated from the wing or fixed member to which the strike is mounted, and therefore reduce the risk of the latch tongue being already extended as the lock or latch is brought into engagement with the strike causing the latch tongue to impact against the strike or the wing/fixed member to which the strike is mounted, causing damage.

In the present invention, the hold back means is magnetically operated only when the lock or latch moves close enough to the strike for the latch tongue to engage the strike, this operation then allowing the latch tongue to move into the latching position. This magnetic operation may be achieved in a number of ways. It is envisaged that, in most embodiments of the invention, at least one of the latch/lock or the strike may be provided with a permanent magnet. If only one magnet is provided on or in the latch/lock or strike, then the other of the latch/lock or strike will be made (or parts of it will be made) from metal such that an attractive force between the magnet and the metal components(s) is created to operate the hold back means when the lock or latch moves close enough to the strike for the latch tongue to engage the strike Preferably, both the lock/latch and the strike may be provided with a permanent magnet. These may be referred to as the lock/latch magnet and the strike magnet respectively. Suitably, the attractive or repulsive force created between the lock/latch magnet and the strike magnet when the lock or latch moves close enough to the strike for the latch tongue to engage the strike may operate the hold back means to allow the latch tongue to move to the latching position.

Whilst it is envisaged that most embodiments of the invention will typically operate using one or more permanent magnets, the invention is not necessarily limited to this. For example, the lock or latch may be provided with a solenoid (or some similar electromagnetic device) which becomes magnetised when an electric current is passed through or applied to it. In these cases, an electric current may be passed through or applied to the solenoid or other device to create a magnetic field which, when the lock or latch moves close enough to the strike for the latch tongue to engage the strike, gives rise to a magnetic force of sufficient magnitude to operate the hold back means and allow the latch tongue to move into the latching position. The electric current could be applied at all times, or only when the lock or latch moves close enough to the strike for the latch tongue to engage the strike. Alternatively, the electric current could be applied at all times except when the lock will latch moves close enough to the strike for the latch tongue to engage the strike, and the sensation of the current may remove the magnetic field thereby operating the hold back means (or allowing it to operate) to thereby allow the latch tongue to move into the latching position. A combination of permanent magnets and electro magnets may also be possible.

The holdback means may comprise or include a holdback member which can move between a first position in which the latch tongue is prevented from moving to the latching position, and a second position in which the latch tongue can move to the latching position. Suitably, when the holdback member is in the first position, it may engage with the latch tongue to prevent the latch tongue from moving to the latching position, and when the holdback member is in the second position, it may disengage from the latch tongue so as not to prevent the latch tongue from moving to the latching position. The holdback member may be a rotating or pivoting member. In other words it may pivot between the first position and the second position. In particularly preferred embodiments, the holdback member may have a permanent magnet in, on or otherwise mounted to it such that, when the lock or latch moves close enough to the strike for the latch tongue to engage the strike, an attractive or repulsive magnetic force is created to move the member from the first position to the second position.

The invention may also be provided with lockout means. The lockout means may prevent the latch tongue from moving from the latching position back to the free position otherwise than upon operation of the handle or other mechanism used to open or “un-latch” the latch or lock. Hence, the lockout means may provide security against any attempt to use a foreign object to drive the latch tongue from the latching position to the free position. Preferably, the lockout means may comprise a component which engages with the latch tongue upon the latch tongue moving into the latching position, and which can only be disengaged from the latch tongue by operation of the handle or other mechanism normally used to open or “un-latch” the lock or latch. The lockout component may be biased towards the position in which it engages with the latch tongue to prevent the latch tongue from moving from the latching position back into the free position.

A hub may be provided for disengaging the lockout means to enable the latch tongue to move from the latching position to the free position. The hub may also operate to move the latch tongue from the latching position to the free position (although it may not necessarily move the latch tongue from the free position to the latching position). Preferably the hub may be a rotating component. It may be rotated by operating the handle or other mechanism normally used to “un-latch” the lock or latch. Suitably, the initial rotation of the hub may disengage the holdback means from the latch tongue thereby freeing the latch tongue to move from the latching position to the free position. Further rotation of the hub may then cause the latch tongue to move from the latching position to the free position.

The lock or latch may have a casing inside which the components of the lock or latch may be contained. The casing may comprise a base and to cover which together form the casing when assembled. The internal components of the lock or latch may be mounted to the base, the cover, or a combination of both. In this regard, the “internal components” of the lock or latch includes the latch tongue, even though the latch tongue may extend out through an aperture in the casing when in the latching position, at least in some embodiments. The casing (i.e. the base or the cover) may have means to enable it to be mounted to a wing (for example, but not limited to, holes for the insertion of screws). It may also have sufficient mounting means and features inside to enable the internal components to be mounted for interoperation therein.

### BRIEF DESCRIPTION OF THE DRAWINGS

Certain background information is provided in the section entitled “background” above. That background information is provided solely for the purpose of assisting in understanding, and providing context for, the invention, and it makes reference to the earlier drawings in which:

FIGS. 1 and 2 show a prior art sliding door lock with a rotating “parrot beak” type latch tongue, and which incorporates a hold back mechanism that gives the lock a self latching function; and

FIG. 3 shows a prior art door lock for a hinged door which has an “in-out” sliding latch tongue, and which also incorporates a hold back mechanism that gives the lock a self latching function.
One particularly preferred (but non-limiting) embodiment of the present invention, in the form of a latch mechanism for a double hung window, is described below with reference to the latter drawings in which:

FIG. 4 shows a typical double hung window;

FIG. 5 is a sectional plan view of the latch when engaged with the strike (notably the latch tongue is in the latching position where it engages with the strike);

FIG. 6 is a sectional plan view of the latch similar to FIG. 5, except that the latch is separated from the strike (so the strike is not visible);

FIG. 7 shows certain other internal components of the latch which are mounted to the latch cover, not the latch base, and which therefore are not shown in FIGS. 5-6;

FIG. 8 is a side view of the internal components of the latch shown in FIG. 7; and

FIG. 9 is a plan view of the external furniture and handle of the latch.

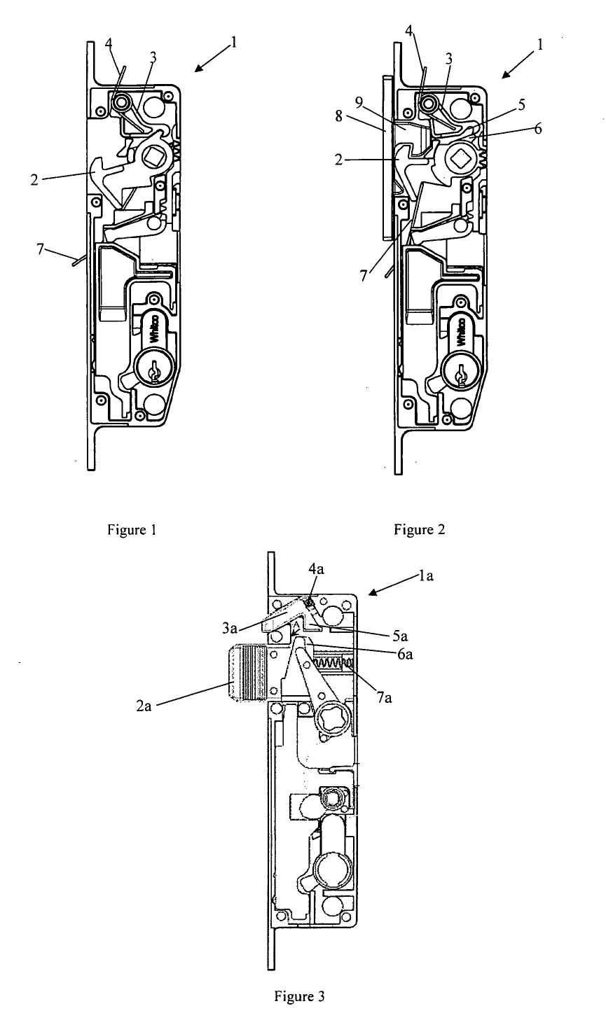

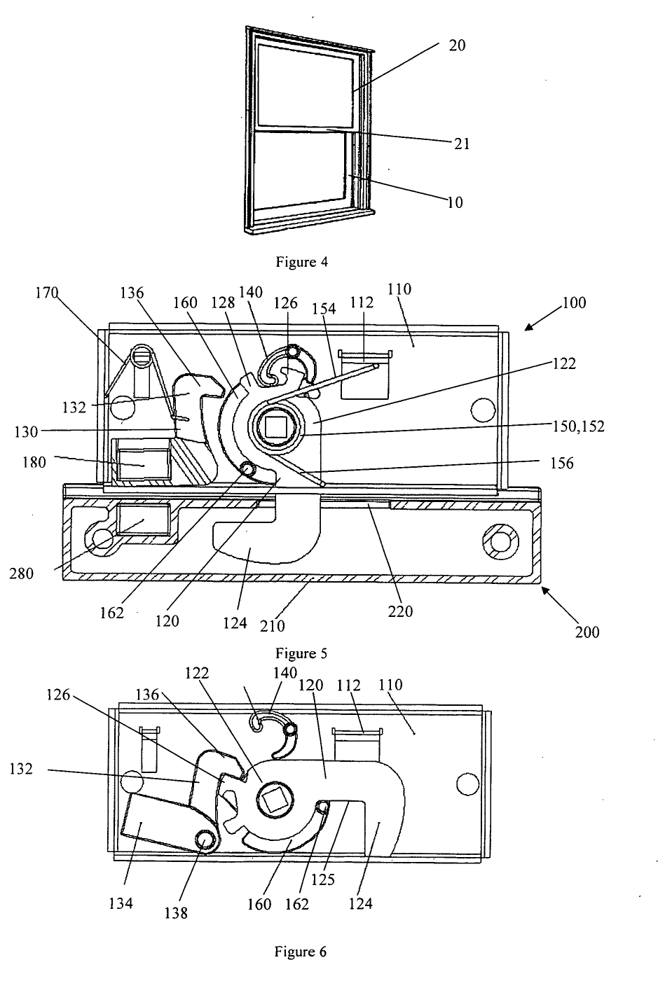

### DETAILED DESCRIPTION OF FIGS. 4-8

As mentioned above, the embodiment of the invention presently described is a latch mechanism for a double hung window. FIG. 4 shows a typical double hung window from the outside. The double hung window comprises a first sash 10 (which is the inner sash in this case), and a second sash 20 (which is the outer sash in this case). When the two sashes are in the closed configuration shown in FIG. 4, the lower horizontal edge 21 of the frame of second sash overlaps with the upper horizontal edge (not visible) of the frame of the first sash.

From FIG. 5 it can be seen that the latch mechanism comprises a latch 100, and a strike which will be referred to as the keeper 200. The latch 100 comprises a base 110, a latch tongue 120, a hold back member 130, a lockout cam 140, a main spring 150, a hub 160 and an auxiliary spring 170. The keeper 200 comprises a casing 210 having an opening 220 through which the latch tongue 120 can enter to hookingly-engage with the keeper, and a strike magnet (hereafter called the keeper magnet 280).

The keeper 200 would be mounted on the inside of the lower horizontal edge 21 of the frame of the second sash 20 in FIG. 4. The latch 100 would be mounted to the upper horizontal edge (not shown) of the frame of the first sash 10 in FIG. 4. The latch 100 should be mounted to the inner sash so that the latch can be operated from the inside. Thus, when the sashes 10 and 20 are moved into the closed configuration shown in FIG. 4, the keeper 200 will be aligned with the latch 100 so that the latch tongue 120 can insert through the opening 220 in the keeper, as shown in FIG. 5 and described further below.

The latch tongue 120 is a rotating “parrot beak” type latch tongue. It has a rounded end 122 pivotally mounted to the base 110. The latch tongue 120 therefore pivots relative to the base 110 about the rounded end 122. The pivotal movement of latch tongue 120 can be seen by comparing FIGS. 5 and 6. The latch tongue 120 also has a hook shaped distal and 124 which can pivot out from within the base 110 to engage with the keeper 200 by inserting through opening 220. It will be appreciated from FIG. 5 that, when the latch tongue 120 engages with the keeper 200 as shown, if an attempt is made to move the latch 100 (or the first sash 10 to which the latch is mounted) relative to the keeper 200 (or the second sash 20 to which the keeper is mounted), without “opening” or “unlatching” the latch, the portion of the latch tongue which is inside the keeper 200 will collide with a wall of the keeper casing 210 to prevent movement of the latch 100 (and first sash 10) relative to the keeper 200 (and second sash 20). Also, if an attempt is made to separate latch 100 from keeper 200 in the direction perpendicular to the plane of the sashes (e.g. by trying to force something between them to prise them apart), the hooked portion 124 of the latch tongue will collide with the inside wall of the keeper casing 210, near the opening 220, thereby preventing separation of the latch from the keeper.

The latch tongue 120 is biased by main spring 150 towards the latching position shown in FIG. 5. The main spring 150 comprises helical portion 152 which is coaxial with the pivot axis of the latch tongue 120, a first arm portion 154 which presses against a fixed upstanding wall portion 112 on base 110, and a second arm portion 156 which hooks around the straight edge of the latch tongue as shown in FIG. 5 to bias the latch tongue. When the latch is “opened” or “unlatched” (as described further below), the latch tongue 120 is caused to rotate from the latching position to the free position (i.e. anti-clockwise in the illustrations from the position shown in FIG. 5 to the position shown in FIG. 6), and this compresses main spring 150 by bringing the arm portions 154, 156 together causing additional twisting of the helical portion 152. Conversely, when the hold back mechanism is activated (as also described further below), the latch tongue 120 is caused to rotate from the free position to the latching position (i.e. clockwise from the position shown in FIG. 6 to the position shown in FIG. 5) due to the un-twisting of the to helical portion 152 of the spring, which causes the arms 154, 156 to move apart.

The hold back member 130 comprises a first leg 132 and a second leg 134. Legs 132 and 134 are configured so that, together, they give the hold back member a general L-shape. The first leg 132 has a hooked portion 136 on its free end which can engage with a lug 126 on the lock tongue, as shown in FIG. 6. The second leg 134 of the hold back member is positioned close to the front wall of the base 110, and it contains a latch magnet 180. The hold back member 130 is pivotally mounted to the base 110 so that it can pivot, relative to the base, about the corner 138 where the legs 132, 134 intersect.

The hold back member 130 can pivot between a first position (shown in FIG. 6) and a second position (shown in FIG. 5). The hold back member 130 is biased towards the first position by auxiliary spring 170. Auxiliary spring 170 is similar to main spring 150 in that it comprises a helical portion and two elongate arm portions. In the case of auxiliary spring 170, one of the arm portions engages with the inside casing of latch base 110, and the other arm portion engages with the first leg 132 of the hold back member 130 to bias the hold back member. When the latch is “closed” or “latched” (for reasons described further below) the hold back member 130 is caused to rotate from the first position to the second position (i.e. anti-clockwise in the illustrations from the position shown in FIG. 6 to the position shown in FIG. 5), and this compresses auxiliary spring 170 by bringing the arm portions together causing additional twisting of the helical portion of the spring. Conversely, when the latch is “opened” or “unlatched” (as described further below), the hold back member 130 rotates from the second position to the first position (i.e. clockwise from the position shown in FIG. 5 to the position shown in FIG. 6) due to the un-twisting of the helical portion of the auxiliary spring 170, which causes the arms of the auxiliary spring to move apart, thereby pivoting the hold back member 130.

To understand the operation of the latch mechanism, it is useful to begin with FIG. 6. FIG. 6 shows the latch 100 when the latch tongue 120 is in the free position. In this position, the hooked end 124 of the latch tongue is rotated (i.e. retracted) inside the latch base 110. FIG. 6 also shows that, when the latch tongue 120 is in this position, the hooked end 136 of the hold back member's first leg 132 engages with the lug 126 on the rounded pivot end of latch tongue. This prevents the latch tongue 120 from pivoting (clockwise) into the latching position. Also, the biasing influence of the auxiliary spring 170 prevents the hold back member 130 from pivoting out of engagement with the lug 126.

FIG. 6 may then be contrasted with FIG. 5. In FIG. 5, the latch 100 is shown in engagement with the keeper 200. In general, as the latch 100 engages with the keeper 200, or as the latch 100 moves into close proximity with the keeper 200, the proximity between the keeper magnet 280 and the latch magnet 180 gives rise to an attractive force between the magnets. This attractive force is sufficient to pivot hold back member 130 (anti-clockwise), against the bias of auxiliary spring 170, from the first position shown in FIG. 6 to the second position shown in FIG. 5.

It should be noted that, in this embodiment, both latch magnet 180 and keeper magnet 280 are permanent bar magnets. Those skilled in the art will therefore appreciate that the latch and keeper magnets should be arranged so that the north pole of one magnet is oriented towards the south pole of the other magnet so as to cause an attractive force between the magnets when the magnets brought close together. It will also be appreciated that the magnitude of the attractive force between the opposite poles of the respective magnets increases as the separation between the magnets is reduced. The relationship between the size of the separation between the magnets and the magnitude of the attractive force is generally not linear (rather it is generally some form of inverse square relationship). Hence, the force of attraction may be quite low (certainly much less than is required to overcome the bias of auxiliary spring 170), or even negligible, when the keeper magnet 280 and the latch magnet 180 are spaced, say, more than a few centimetres apart. However, when the latch 100 and the keeper 200 are brought close together such that the spacing between the magnets is very small (say a couple of centimetres or less) the magnitude of the attractive force may increase dramatically. Then, as the latch 100 moves closer to the keeper 200, the magnitude of the attractive force will become sufficient to overcome the bias of auxiliary spring 170. Therefore, reference to the bringing of the latch into close proximity with the keeper should be understood as meaning positioning the latch and the keeper with respect to each other such that the spacing between the two is sufficiently small to give rise to a sufficient attractive force between the magnets to overcome the bias acting on the hold back member.

Returning to FIG. 5, it will be understood that when the hold back member 130 has moved into the second position due to the attractive force between the magnets, the hold back member 130 no longer prevents the latch tongue 120 from pivoting into the latching position. Consequently, the latch tongue pivots into the latching position, as shown in FIG. 5, due to the bias of main spring 150 described above.

FIG. 5 also shows that, when the latch tongue 120 moves into the latching position, the lockout cam 140 rotates so that the hook shaped end of the lockout cam inserts between the lugs 126 and 128 on the rounded end of the latch tongue 120. The lockout cam 140 is biased towards the position shown in FIG. 5. The purpose of the lockout cam 140 is to prevent the latch tongue 120 from being pivoted back into the free position, except by operation of the handle as described below. Hence, if for example a thin implement was inserted between the latch 100 and the keeper 200 to try and force the latch tongue 120 back from the latching position into the free position in order to then separate the latch from the keeper, the hook shaped end of lockout cam 140 would engage with the correspondingly shaped nook in lug 126 to prevent this. The only way to disengage the lockout cam 140 (i.e. to pivot the lockout cam 140 against its bias so that its hooked end does not engage between the lugs on the latch tongue) is by operating the handle which in turn operates the hub 160, as described below.

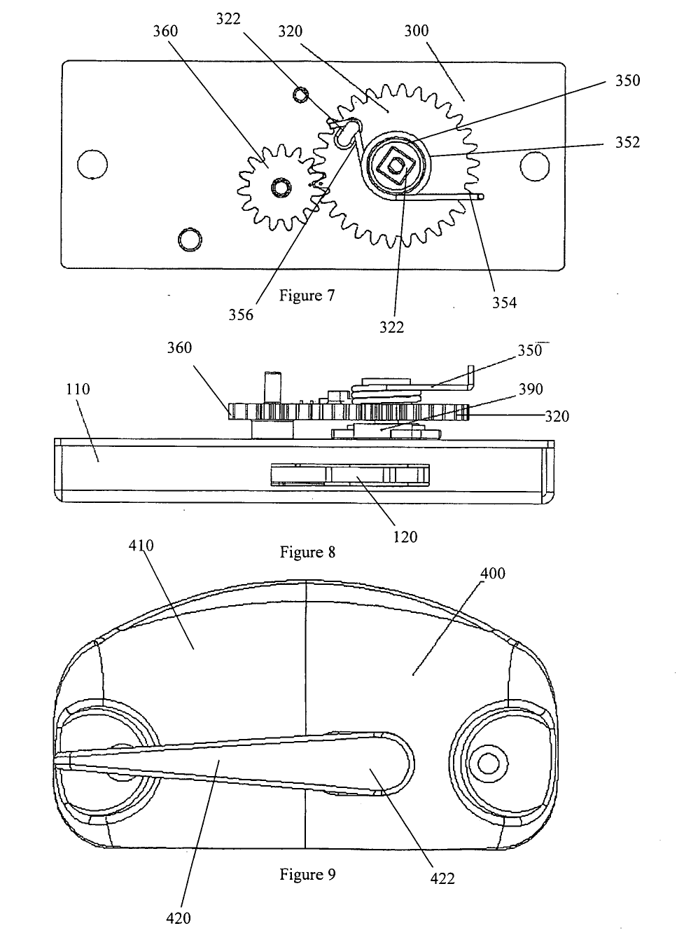

The external furniture of the latch 400 is shown in FIG. 9. The external furniture includes a handle 420. In this particular embodiment the handle 420 is a pivoting lever-type handle. FIG. 7 shows the cover 300 of the latch. The cover 300 has a number of components mounted to it, including a handle gear 320, a hub gear 360 and a handle spring 350. The cover 300 is assembled to the base 100 such that the components mounted to the cover engage with and operate the components mounted to the base, as described further below.

As mentioned above, the handle 420 is a pivoting handle. It pivots about the rounded end 422. Attached to the rounded end 422 of the handle, and extending through the furniture 400 and into the latch (i.e. extending into the page in FIG. 9), is an elongate square spindle (not shown). The square spindle inserts into the corresponding square aperture 322 in the handle gear 320 (see FIG. 7). Hence, any pivoting movement of the handle 420 is transmitted via the spindle to cause a corresponding amount of rotation of the handle gear 320.

As also mentioned above, the latch tongue 120 cannot be pivoted from the latching position into the free position unless the hub 160 operates to rotate the lockout cam 140 out of engagement with the latch tongue. In addition to disengaging the lockout cam 140, the hub 160 also functions to pivot the latch tongue 120 from the latching position to the free position. This is described further below.

The handle gear 320 meshes with the hub gear 360. Consequently, pivoting handle 420 causes handle gear 320 to rotate, which in turn causes hub gear 360 to rotate. The hub 160 is connected to the hub gear 360, so pivoting the hub gear 360 in this way also causes the hub 160 to rotate. The hub gear 360 is smaller than the handle gear 320. Therefore, rotation of handle 420 through a small angle (which causes of the handle gear 320 two rotate through the same angle) will cause the hub gear 360 (and hence the hub 160) to rotate through a larger angle.

Referring again to FIGS. 5 and 6, it will be seen that the hub 160 has an upstanding post 162 on its outer edge. By comparing FIGS. 5 and 6, it will be seen that, when the hub 160 rotates as described in the previous paragraph (this rotation is anti-clockwise in the illustrations), the post 162 contacts with a flat surface 125 on the latch tongue. Hence, this rotation of the hub 160 causes the post 162 to push on the latch tongue, thereby pivoting the latch tongue from the latching position to the free position. However, it will be recalled that, before the latch tongue can pivot from the latching position to the free position in this way, the lockout cam 140 must first be disengaged. The way this is achieved is explained below.

In FIG. 5, it will be seen that there is a space between the post 162 and the flat face 125 of the latch tongue. This is the position which the hub 160 (and hence the post 162) adopts prior to rotation of the handle 420 (and hence prior also to the rotation of the gears 320, 360). Consequently, there is a small amount of initial rotation of the hub 160 (i.e. the rotation required for the post 162 to move across the space) which does not cause rotation of the latch tongue 120. Therefore, the initial movement of the handle 420 (and hence the initial rotation of the gears) does not affect rotation of the latch tongue. However, this initial movement of the handle (and gears) does cause the hub 160 two rotate. In fact, this initial rotation of the hub 160 operates the lockout cam 140, thus rotating the hooked portion of lockout cam out of engagement with the latch tongue.

Therefore, in summary, the initial rotation of the hub 160 disengages the lockout cam 140, and during this initial rotation of the hub 160, the post 162 is moving across the space shown in FIG. 5. Consequently, the post 162 does not engage the flat surface 125 of latch tongue to commence pivoting the latch tongue until after the lockout cam 140 is disengaged.

It will be noted that the hub 160 is required to rotate through an angle slightly greater than 90° when moving from the position shown in FIG. 5 to the position shown in FIG. 6. In other words, to disengage the lockout cam 140 and then pivot the latch tongue 120 90° from the free position to the latching position, the hub 160 must rotate through slightly more than 90°. However, as noted above, the handle gear 320 is larger than the hub gear 360. Therefore, the handle 420 only needs to rotate through a small angle to cause this 90°+ rotation of the hub. In the particular embodiment shown, the handle gear 320 is twice the size of the hub gear 360, and therefore the handle gear 320 (and hence handle 420) only need to rotate through half the angle that the hub 160 must rotate through.

When the handle 420 is used as described above to rotate the latch tongue 120 from the latching position to the free position (where the latch tongue is retracted out of the keeper), and if the latch 100 is then moved away from the keeper 200, the attractive magnetic force holding the hold back member 130 in the second position is removed. Therefore, the hold back member 130 will pivot (clockwise) under the bias of the auxiliary spring 170, and the hooked end 136 of the holdback member's first leg will again engage with the lug 126 on the latch tongue to secure the latch tongue in the free position and prevent it from pivoting into the latching position.

Whilst the latch tongue 120 is held in the free position when the latch 100 is moved away from the keeper 200, the handle 420 is nevertheless able to pivot back into the un-rotated position shown in FIG. 9 after the latch has been operated to withdraw the latch tongue. The handle 420 actually is biased towards this un-rotated position by the handle spring 350. The handle spring 350 comprises a helical portion 352 which is coaxial with the pivot axis of the handle gear 320, a first arm portion 354 which inserts into the body of cover 300 as shown in FIG. 7, and the second arm portion 356 which hooks around a protrusion 322 on the handle gear 320 to bias the handle gear.

The reason the handle is able to pivot back to its original position even while the latch tongue 120 is retained in the free position is because, as the handle returns to its original position, the post 162 on the harbour simply rotates back unimpeded from the position shown in FIG. 6 to the position shown in FIG. 5. Hence, after the user has manipulated (i.e. rotated) the handle 420 to pivot the latch tongue from the latching position to the free position, the hub 160, hub gear 360, handle gear 320 and handle 420 all return to their original un-rotated positions under the bias of handle spring 350.

However, to prevent the handle 420 (and the gears and hub etc) from simply “snapping back” into their original un-rotated positions after the use of lets go of the handle, a rotary temper 390 is provided. The rotary damper 390 does not prevent the handle, gears, hub etc from returning to their original un-rotated positions under the bias of the handle spring 350, but it slows the rate of their return so as to prevent the handle from “snapping back” which goods cause injury to the user or damage to the latch if done repeatedly.

Because the handle 420 returns to its un-rotated position after the user lets go, handle will not then move from its un-rotated position when the latch 100 is again brought into engagement, or moved into close proximity with, the keeper 200 whereupon the holdback member 130 will disengage (due to the attractive magnetic force) allowing the latch tongue 120 to pivot into the latching position as described above. The fact that the handle does not move when the latch tongue “latches” also helps to reduce the risk of possible injury to the user.

It will be seen from FIG. 9 that the latch furniture 400 incorporates and arcuate outer portion 410. The arcuate outer portion 410 is there to assist the user in moving the first sash 10 after the handle 420 has been operated to withdraw the latch tongue. More specifically, the user may place their thumb underneath the arcuate portion 410, or otherwise manually grasped the arcuate portion, in order to move the first sash 10 (typically to slide the sash upwards away from the closed position shown in FIG. 4, or downwards to return it to the closed).

Various other changes and modifications may be made to the particular embodiment of the self latching latch just described without departing from the spirit and scope of the invention.

1. A latch for use with an openable and closable wing comprising
a latch tongue which can move between a latching position and a free position,
an operator for moving the latch tongue from the latching position to the free position,
biasing means to bias the latch tongue towards the latching position,
a hold back mechanism to prevent the latch tongue from moving to the latching position except when the latch is close enough to an associated strike for the latch tongue to engage the strike, wherein the hold back mechanism is magnetically operated when the latch is close enough to the strike for the latch tongue to engage the strike such that the latch tongue can move to the latching position and engage the strike, and
a lockout mechanism to prevent the latch tongue from moving from the latching position to the free position otherwise than upon operation of the operator.

2. A latch as claimed in claim 1, wherein the latch tongue is a rotating latch tongue having a portion which is substantially hook shaped to hook into, or hookingly engage with, the strike when the latch tongue is in the latching position.

3. A latch as claimed in claim 2, wherein the operator comprises a handle which moves in a pivoting manner and a spindle member is provided that is functionally associated with the handle and the latch tongue so that pivoting the handle causes the latch tongue to rotate.

4. A latch as claimed in claim 3, wherein at least one of the latch or the strike is provided with a permanent magnet.

5. A latch as claimed in claim 4, wherein the latch is provided with a latch magnet and the strike is provided with a strike magnet and the attractive or repulsive force created between the latch magnet and the strike magnet when the latch moves close enough to the strike for the latch tongue to engage the strike operates the hold back mechanism to allow the latch tongue to move to the latching position.

6. A latch as claimed in claim 5, wherein the hold back mechanism comprises a hold back member which can move between the first position in which the latch tongue is prevented from moving to the latching position, and a second position in which the latch tongue can move to the latching position.

7. A latch as claimed in claim 6, wherein the hold back member can pivot between first and second positions, and in the first position it engages with the latch tongue to prevent the latch tongue from moving to the latching position, and in the second position it disengages from the latch tongue so as not to prevent the latch tongue from moving to the latching position.

8. A latch as claimed in claim 1, wherein the lockout mechanism includes a component which can move to engage with the latch tongue upon the latch tongue moving into the latching position, and which can only be disengaged from the latch tongue by operating the operator.

9. A latch as claimed in claim 8, wherein the lockout component is biased towards the position in which it engages with the latch tongue to prevent latch tongue from moving from the latching position to the free position.

10. A latch as claimed in claim 9, wherein a hub is provided for disengaging the lockout component to enable the latch tongue to move from the latching position to the free position.

11. A latch as claimed in claim 10, wherein the hub also assists with moving the latch tongue from the latching position to the free position upon operation of the operator.

12. A latch as claimed in claim 11, wherein the hub is a rotating component which can be rotated by operating the operator.

13. A latch as claimed in claim 12, wherein initial rotation of the hub disengages the lockout mechanism thereby freeing the latch tongue to move from the latching position to the free position, and further rotation of the hub causes the latch tongue to move from the latching position to the free position.

14. A mechanism for, or included in, a lock or latch, the lock or latch being of the type which has
a latch tongue which can move between a latching position and a free position,
an operator for moving the latch tongue from the latching position to the free position, and
means to bias the latch tongue towards the latching position,
wherein the mechanism
prevents the latch tongue from moving to the latching position when the lock or latch is separated from an associated strike,
can be magnetically operated, when the latch is close enough to an associated strike for the latch tongue to engage the strike, so that the mechanism does not prevent the latch tongue from moving to the latching position, and
prevents the latch tongue from moving from the latching position to the free position otherwise than upon operation of the operator.

15. A latch mechanism including
a latch mounted to a first wing and
a strike mounted to a second wing or a fixed member,
the latch having
a latch tongue which can move between a latching position in which the latch tongue can engage the strike to secure the first wing relative to the second wing or fixed member, and a free position which allows relative movement between the first wing and the second wing or fixed member,
latch tongue biasing means to bias the latch tongue towards the latching position,
latch tongue operating means to move the latch tongue from the latching position to the free position,
a hold back member which can move between a first position in which the latch tongue is prevented from moving to the latching position, and a second position in which the latch tongue can move to the latching position,
hold back member biasing means to bias the hold back member to the first position,
a latch magnet associated with the hold back member, and
latch tongue lockout means to prevent the latch tongue from moving from the latching position to the free position otherwise than upon operation of the latch tongue operating means the strike having a strike magnet
whereby when the latch is close enough to the strike for the latch tongue to engage the strike the hold back member is caused to move from the first position to the second position by attractive or repulsive magnetic forces between the latch magnet and the strike magnet, thereby allowing the latch tongue to move from the free position to the latching position.

16. A lock as claimed in claim 15, wherein the first and second wings comprise sashes of a double hung window.
